(19) United States
(12) Patent Application Publication
(10) Pub. No.: US 2007/0271506 A1
(43) Pub. Date: Nov. 22, 2007

(54) Configurable information transmission

(76) Inventors: Steven Sholtis, El Dorado Hills, CA (US); Kenneth J. Henderson, Folsom, CA (US)

Correspondence Address: GUNNISON, MCKAY & HODGSON, L.L.P., 1900 GARDEN ROAD, SUITE 220, MONTEREY, CA, 93940, US

(21) Appl. No.: 11/438,057

(22) Filed: May 18, 2006

(51) Int. Cl. G06F 17/00; G06F 15/16

(52) U.S. Cl. 715/513; 709/203; 715/523

(57) ABSTRACT

Systems, methods and computer program products for facilitating configurable information transmission are disclosed. Configurable information transmission may be used in the context of transmitting information intended for different presentation modes, including system to system (machine to machine) presentation and system to user (machine to person) presentation. In one embodiment, the method includes receiving from a first server a request for the information together with a format indication, with the format indication including a data indication and/or a display indication. In one embodiment, the method includes transmitting by a second server, responsive to the format indication including a data indication, the information embedded in a data description markup language. In one embodiment, the method includes transmitting by the second server, responsive to the format indication including a display indication, the information in a user interface component embedded in a data description markup language, with the user interface component expressed in a display description markup language. In various embodiments, the method includes transmitting a request for information. Other embodiments are disclosed.

### BACKGROUND

The present invention relates to the transmission of information in connection with various presentation modes, including system to system presentation and system to user presentation.

Transmitting information in connection with a markup language may arise in a wide variety of contexts. One such context, for example, includes web services relating to websites. Websites are often a mix of technologies, protocols, hardware, and software from multiple vendors. This mix often results in a complex and tightly integrated system. Web services are an example of one technology that may be used to add new services, or extend existing services, to a web site. In such a context, the system integrator often goes through a multi-step process, which may include: learning how to use the vendor-specific application programming interface (API) exposed by the web service, understanding and interpreting the data returned from the web service API, transforming the data, and integrating it into web pages.

### SUMMARY

In various embodiments, the present invention provides systems, methods and computer program products for facilitating configurable information transmission. Configurable information transmission may be used in the context of transmitting information intended for different presentation modes, including system to system (machine to machine) presentation and system to user (machine to person) presentation. In one embodiment, the method includes receiving from a first server a request for the information together with a format indication, with the format indication including a data indication and/or a display indication. In one embodiment, the method includes transmitting by a second server, responsive to the format indication including a data indication, the information embedded in a data description markup language. In one embodiment, the method includes transmitting by the second server, responsive to the format indication including a display indication, the information in a user interface component embedded in a data description markup language, with the user interface component expressed in a display description markup language. In various embodiments, the method includes transmitting a request for information. Other embodiments are disclosed.

One skilled in the art will recognize that the present invention can be implemented in a wide variety of applications that involve the transmission of information in connection with a markup language. Various embodiments of the invention can be implemented in different manners, including as a feature of a software package, or as a feature of a web-based application or website, or as a plug-in that can be installed and used in connection with an existing software application.

### BRIEF DESCRIPTION OF THE DRAWINGS

FIG. 1 is a block diagram illustrating some aspects of an architectural overview of the present invention according to one embodiment.

FIG. 2 is a flow chart illustrating a method of practicing the present invention according to one embodiment.

FIG. 3 is a block diagram illustrating the architecture of a system useful for supporting a software application for transmitting a request for information according to one embodiment of the present invention.

FIG. 4 illustrates a user interface of an application generated using techniques of one embodiment of the present invention.

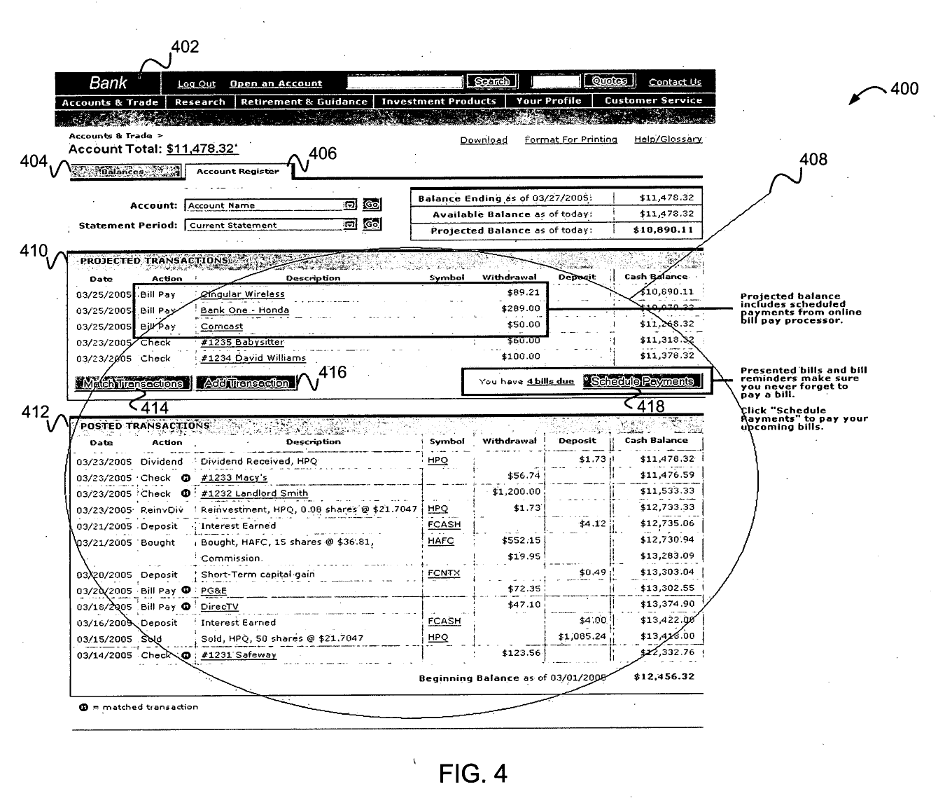

One skilled in the art will recognize that these Figures are merely examples of the operation of the invention according to one embodiment, and that other architectures, user interface arrangements and modes of operation can be used without departing from the essential: characteristics of the invention. In particular, the user interface elements shown in FIG. 4 are merely exemplary; other layouts, arrangements, formats, and user interface features may be provided without departing from the essential characteristics of the present invention.

### DETAILED DESCRIPTION OF THE EMBODIMENTS

The present invention is now described more fully with reference to the accompanying Figures, in which one embodiment of the invention is shown. The present invention may be embodied in many different forms and should not be construed as limited to the embodiments set forth herein. Rather these embodiments are provided so that this disclosure will be complete and will fully convey principles of the invention to those skilled in the art.

In various embodiments, configurable information transmission may be used in the context of transmitting information intended for different presentation modes, including system to system (machine to machine) presentation and system to user (machine to person) presentation. Type-specific data may be used for different presentation modes. For example, a data transfer in connection with a data markup language, such as EXtensible Markup Language (XML), may be use for machine to machine presentation. Also, for example, a data transfer in connection with a display markup language, such as Hyper Text Markup Language (HTML), may be used for machine to user presentation. In various embodiments, user-destined data may be in machine to user presentation format, but may be passed in a machine to machine presentation format, sometimes through another machine.

For illustrative purposes, embodiments of the invention are described in connection with the display of financial reports, including reports related to a personal banking account. Various specific details are set forth herein and in the Figures to aid in understanding the present invention. However, such specific details are intended to be illustrative, and are not intended to restrict in any way the scope of the present invention as claimed herein. In particular, one skilled in the art will recognize that the invention can be used in connection with any application involving processing information, where the user can request that information or information summaries and where the information is viewed within a graphical user interface. In addition, the particular user interface layouts, appearance, and terminology as depicted and described herein, are intended to be illustrative and exemplary, and in no way limit the scope of the invention as claimed. Various embodiments of the invention may be used in many different contexts of user interaction with various forms of information, including, for example, the contexts of medical information, entertainment information, educational information, business information, information related to purchasing/selling goods/services, and communication information (e.g., messages, in various forms).

In some embodiments, the present invention is implemented at least partially in a conventional server computer system running an operating system (OS) such as a Microsoft OS, available from Microsoft Corporation of Redmond, Wash.; various versions of Linux; various versions of UNIX; a MacOS, available from Apple Computer Inc. of Cupertino, Calif.; and/or other operating systems. In some embodiments, the present invention is implemented in a conventional personal computer system running an OS such as Microsoft Windows XP (or another Windows version), MacOS X (or another MacOS version), various versions of Linux, various versions of UNIX, or any other OS designed to generally manage operations on a computing device. In some embodiments, the present invention may be implemented on both client and server computer systems, while in other embodiments, the present invention may be implemented on one type of computer system.

In addition, the present invention can be implemented on, or in connection with, devices other than personal computers, such as, for example, personal digital assistants (PDAs), cell phones, computing devices in which one or more computing resources is located remotely and accessed via a network, game consoles and set-top boxes. The invention may be included as add-on software, or it may be a feature of an application that is bundled with a computer system or sold separately, or it may even be implemented as functionality embedded in hardware.

Output generated by the invention can be displayed on a screen, transmitted to a remote device, stored in a database or other storage mechanism, printed, or used in any other way. In addition, in some embodiments, the invention makes use of input provided to the computer system via input devices such as a keyboard, a mouse, and/or a touchpad. Such hardware components, including their operation and interactions with one another and with a central processing unit of the personal computer, are well known in the art of computer systems and therefore are not depicted here. In addition, for embodiments implemented in devices other than personal computers, other types of input and output components may be used, such as touch screens, thumb-wheels, and/or stylus-based inputs.

Reference in the specification to “one embodiment” or “an embodiment” means that a particular feature, structure, or characteristic described in connection with the embodiment is included in at least one embodiment of the invention. The appearance of the phrase “in one embodiment” in various places in the specification does not necessarily refer to the same embodiment. The appearance of the phrase “in some embodiments” in various places in the specification are not necessarily all referring to the same set of embodiments. The appearance of the phrase “in various embodiments” in various places in the specification are not necessarily all referring to the same set of embodiments.

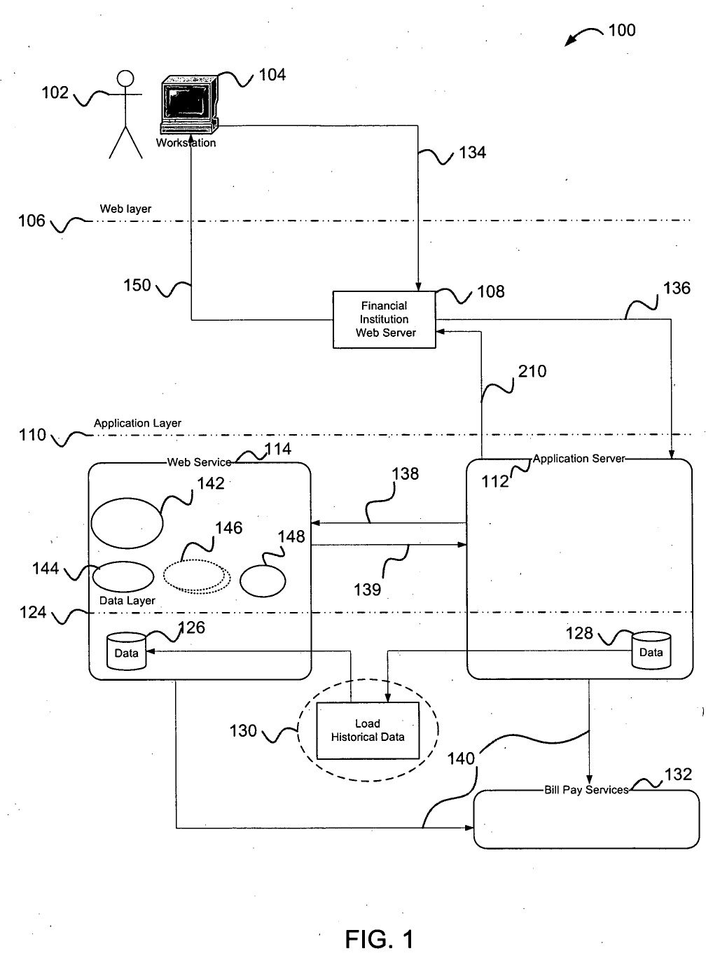

FIG. 1 is a block diagram illustrating some aspects of architectural overview 100 of the present invention according to one embodiment. Architectural overview 100 includes user 102 (for context), workstation 104, web layer 106 (which encompasses financial institution (FI) web server 108), application layer 110 (which encompasses application server 112 and web service 114), data layer 124 (which encompasses data stores 126 and 128), and bill pay services 132. The architectural configuration of FIG. 1 is shown for illustrative purposes only; other configurations are contemplated by and are within the scope of the present invention.

In the exemplar illustration, web service 114 is a web based application that interacts with other web applications via an open or closed standard, and in one embodiment includes a version of the Java Platform, Enterprise Edition, as well as a number of components, including engine core 142, message and function call binding 144 (such as Simple Object Access Protocol (SOAP)), adapters 146, and web service definition language 148. In some embodiments, web service 114 may alternatively or additionally include other components. In some embodiments, other components may alternatively or additionally be used with web service 114. In some embodiments, a web service similar in functionality to a Java platform service may be used. In some embodiments, a version of the Microsoft .NET platform service may be used. In some embodiments, a Java, .NET, or similar such platform may not be used.

Workstations or personal computers are often used to access remote information. Such information may, for example, be in connection with various accounts of a user. In some embodiments, a workstation or personal computer may access a web server. In some embodiments, such a web server may in turn access an application server. In some embodiments, the application server may make a web services call. In accordance with various embodiments of the invention, a web services call may be configurable to return data in a data description markup language and/or a user interface (UI) component expressed in a display description markup language, with the UI component transmitted in a data description markup language.

User 102 can use workstation 104 to view and analyze, for example, user's 102 bank account with a financial institution through an Internet browser. As an illustrative example, user 102 may request a spending analysis for a prior month. Spending analysis request 134 is relayed to FI web server 108 via a Hypertext Transfer Protocol (HTTP) Uniform Resource Locator (URL) request. FI web server 108 runs a Java Server page (as the embodiment of FIG. 1 uses a Java platform service), which includes making Remote Method Invocation (RMI) request 136 for a “spending analysis” HTML component.

RMI request 136 can include a parameter specifying the “spending analysis” request be responded to with an actual HTML component representing the analysis requested, and not the data including the analysis. RMI request 136 can also include a parameter specifying the “spending analysis” request be responded to with the data including the analysis in XML. As described in relation to FIG. 1, the instance in which RMI request 136 includes a parameter specifying the “spending analysis” request be responded to with an actual HTML component representing the analysis requested, is illustrated.

Application server 112 then makes request 138 for the HTML component. As the embodiment of FIG. 1 uses a Java platform service, request 138 may include a Java API for an XML based Remote Procedure Call (JAX-RPC) or SOAP request, or another such Java-compatible exchange.

Web service 114 may make use of historical information made available by operation load historical data 130, for example by transferring data from data store 128 to data store 126. In some embodiments, operation load historical data 130 may take place after request 138, while in other embodiments, operation load historical data 130 may take place at another time, including, for example, in combination with request 138.

Web service 114 performs various operations, such as calculations and mixing historical data with active data, to assemble an HTML component. Web service 114 makes use of components 142-148 as needed, and then relays the HTML component in response 139. As the embodiment of FIG. 1 uses a Java platform service, response 139 may include a JAX-RPC or SOAP response, or another such Java-compatible exchange. In other embodiments making use of a platform service other than a Java-based platform service, request 138 and response 139 may include exchanges compatible with the platform being used.

Application server 112 then returns the HTML component relayed by web service 114 to FI web server 108 via RMI response 210. FI web server 108 then assembles the HTML component into the HTML page being served and returns the HTML page to the caller, workstation 104, via HTTP HTML page response 150. Were user 102 to make a request involving an option to make a bill payment (e.g., spending analysis request 134 included current expenses incurred but not paid, with an option to convert such expenses to paid expenses), bill pay services 132 may be made an active participant in the overall set of transactions. In various embodiments, either one or both of application server 112 and web service 114 may initiate bill requests 140, using a protocol in accordance with the applicable embodiment, such as Open Financial Exchange (OFX), as supported in the illustrative embodiment of FIG. 1.

In the embodiment in FIG. 1, described herein for illustrative purposes, the invention is implemented in a personal financial application in which the application produces a spending analysis. Such a spending analysis may simply be one of many analyses that can be produced via an embodiment of this invention in the context of a personal financial application. Various embodiments of the invention may be used in other contexts in a wide variety of applications, including in the contexts of medical information, entertainment information, educational information, business information, information related to purchasing/selling goods/services, and communication information (e.g., messages, in various forms). It is appreciated that such an embodiment as illustrated in FIG. 1 is merely exemplary, and the present invention, far from being limited to use in such a personal financial application, can be used to enhance the capabilities of applications in a multitude of domains.

While one client, workstation 104, is depicted in FIG. 1 for illustration purposes, many such clients (not shown) may interact with FI web server 108. FI web server 108 may have subsequent interactions with application server 112 corresponding to requests to FI web server 108 initiated by such clients. Likewise, application server 112 may have corresponding subsequent interactions with web service 114. In some of the interactions between application server 112 and web service 114, application server 112 may request information from web service 114, together with an indication that the XML response include the information in an HTML component. The HTML component may then be passed back on through to the applicable client. In some of the interactions between application server 112 and web service 114, application server 112 may request information from web service 114, together with an indication that the desired response include the information in XML format. The applicable information in XML may then be passed back on through to the applicable client.

In some embodiments, FI web server 108 and/or application server 112, separately or in combination, may determine whether an HTML component or the applicable information in XML will be relayed back to a particular client. Such an HTML/XML determination may be based on numerous factors, such as user-based, client-based, or implementation timing-based. As an example of an implementation timing-based determination, HTML may be provided initially until the software infrastructure is developed to make use of the information in XML. Once the software infrastructure is capable of using the information in XML as desired, a change in the indication would cause the information to be delivered by the web service in XML in place of the prior HTML component delivered, in response to the same API request call. As an example of a user-based determination, a financial institution may offer tiered online services for their customers. One tier of online service may provide for the XML transfer so that, for example, extra features may be provided with the display of the information to the user. Another tier of online service may provide for the HTML component so that, for example, display of the information with fewer features is provided to the user. In some embodiments, given a set of clients, a subset of the clients may receive HTML components while another subset of the clients may receive the applicable information in XML. In various embodiments, implementations and their corresponding features will vary.

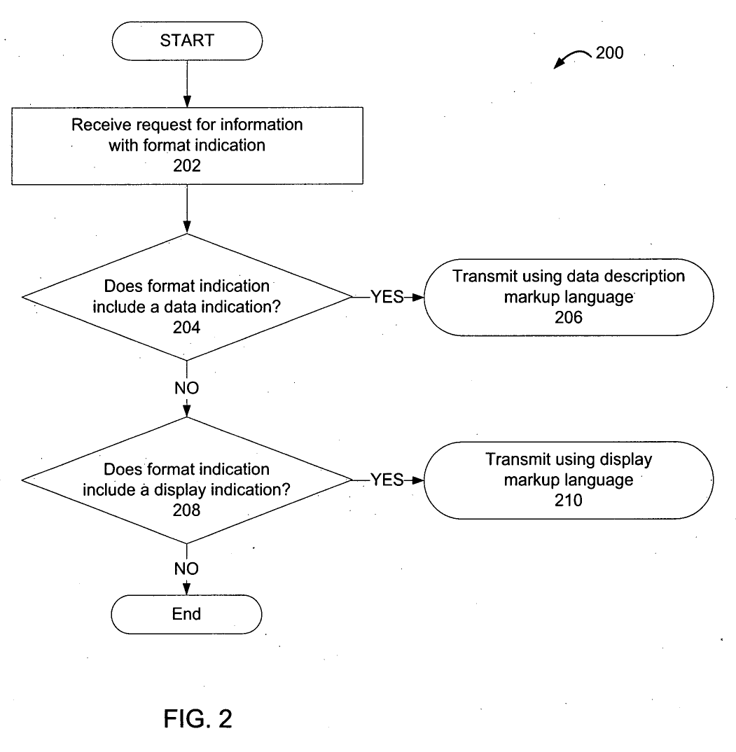

FIG. 2 is a flow chart illustrating a method for configurably transmitting information according to one embodiment of the present invention. A request for information is received 202 together with a format indication. Such a request may be from a first server (not shown). Responsive to the format indication including 204 a data indication, the information is transmitted 206 using a data description markup language. Such a transmission may be from a second server (not shown). The terms “first” and “second” used in connection with “server” herein are not used to convey an order, but to distinguish one server from another server. Responsive to the format indication including a display indication, the information is transmitted 210 in a user interface component embedded in a data description markup language, with the user interface component expressed in a display description markup language. Such a transmission may be from the second server (not shown). While the illustration in FIG. 2 depicts determination 204 occurring in series with determination 208, such determinations may take place in a different manner than in serial fashion, and may take place in another order, in accordance with various embodiments of the invention. In some embodiments, the information may be further transmitted by the first server to a user.

In some embodiments of the invention, the format indication may include a parameter passed in the request. In some embodiments, the format indication may be set in a configuration operation, such as, for example, upon initial set-up or following the steps of a configuration wizard. In some embodiments, the format indication may include another type of format indication. In some embodiments, the request may include a call to an API, while in other embodiments the request may take other forms. In some of the embodiments in which the request includes a call to an API, such an API may include a web services API.

In some embodiments, the data description markup language may include XML, while in other embodiments another data description markup language may be used. In some embodiments, the data display markup language may include HTML. In some embodiments, EXtensible HyperText Markup Language (XHTML) may be used. In other embodiments, another data display markup language may be used.

In some embodiments of a method of configurably requesting information, a request for the information may be transmitted together with a format indication. Such a request may be from a first server. Responsive to the transmitted format indication including a data indication, the information may be embedded in a data description markup language. The information may then be relayed from a second server to the first server. Responsive to the transmitted format indication including a display indication, the information may be embedded in a data description markup language, with the user interface component expressed in a data display markup language. The information may then be relayed from the second server to the first server. In some embodiments, the information may be further transmitted by the first server to a user. In some embodiments, the format indication may include a parameter passed in the request. In some embodiments, the format indication may be specified in a configuration operation, such as, for example, upon initial set-up or following the steps of a configuration wizard. In some embodiments, the format indication may include another type of format indication.

In some embodiments, a request from a first server for the information may be received together with a data format indication and a display format indication, with the data format indication associated with a first subset of the information and the display format indication associated with a second subset of the information. Responsive to the received data format indication, the first subset of the information may be embedded in a data description markup language. The information may then be relayed from a second server to the first server. Responsive to the received display format indication, the second subset of the information may be transmitted in a user interface component embedded in a data description markup language, with the user interface component expressed in a display description markup language. The information may then be relayed from the second server to the first server. In some embodiments, the information may be further transmitted by the first server to a user. In some embodiments, the format indication may include a parameter passed in the request. In some embodiments, the format indication may be specified in a configuration operation, such as, for example, upon initial set-up or following the steps of a configuration wizard. In some embodiments, the format indication may include another type of format indication.

In some embodiments, a call for the information may be received together with a format indication. In some embodiments, the information may be transmitted, by a web services API, in a markup language corresponding to the format indication.

In various embodiments, the methods described herein may be implemented via instructions in the form of computer program code. Such programming code may be encoded in a computer-readable medium and coupled to one or more processors to at least facilitate a computer system in configurably transmitting information. The term, one or more processors, is used herein to include one or more discrete processors, however joined, a single die with multiple processing cores, one or more discrete processors with multiple processing cores themselves, and other forms of multiple processors.

In all of the foregoing, it is appreciated that such embodiments are stated only for the purpose of example, and that other embodiments could equally be provided without departing from the essential characteristics of the present invention.

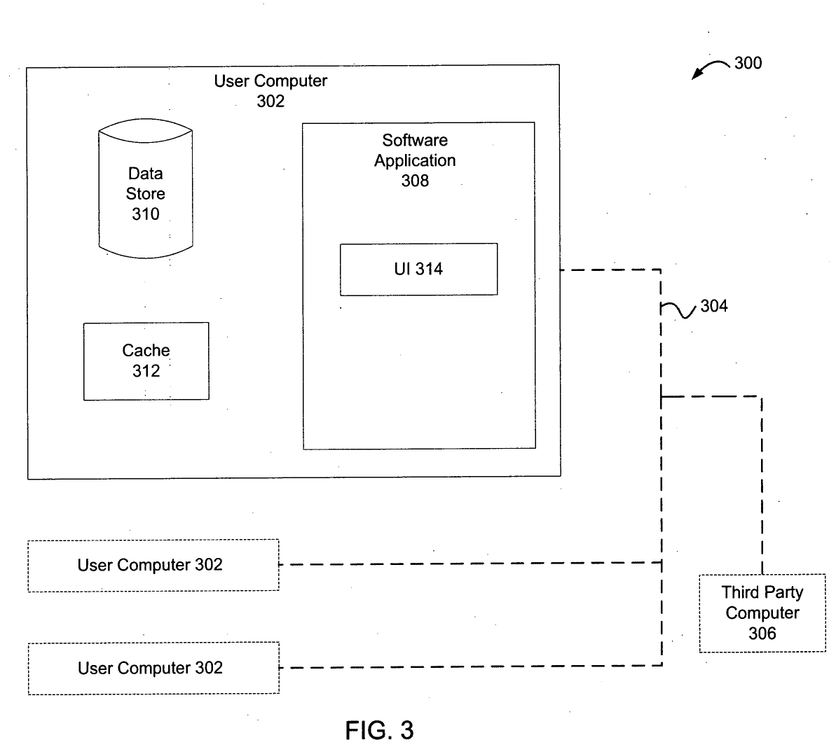

FIG. 3 is a block diagram illustrating the architecture of one embodiment of a system 300 useful for supporting a software application 308 for transmitting a request for information together with a format indication. Responsive to the transmitted format indication including a data indication, software application 308 may receive the information embedded in a data description markup language. Responsive to the transmitted format indication including a display indication, software application 308 may receive the information in a user interface component embedded in a data description markup language, with the user interface component expressed in a data display markup language. Software application 308 may operate in other ways in various other embodiments. In such a system 300, there is provided at least one user computer 302, which may be a stand-alone device or may be communicatively coupled to a network 304 and/or one or more third party computer(s) 306, as indicated by dotted lines.

In one embodiment, the user computer 302 is of conventional design, and includes a processor, an addressable memory, and other conventional features (not illustrated) such as a display, local memory, input/output ports, and a network interface. In other embodiments, one or more of the components of the user computer 302 may be located remotely and accessed via a network, e.g., 304. The network interface and a network communication protocol provide access to a network 304 and other computers, such as other user computers 302 or third party computers 306, along with access to the Internet, via a TCP/IP type connection, or to other network embodiments, such as a LAN, a WAN, a MAN, a wired or wireless network, a private network, a virtual private network, or other networks. In various embodiments, the user computer 302 may be implemented on a computer running a Microsoft OS, a Mac OS, various versions of Linux, various versions of UNIX, a Palm OS, and/or other operating systems.

The third party computers 306, if present, may be server computer systems. For example, one embodiment of a third party computer 306 is a financial institution computer system, which provides online banking functionality for user software application 308. The financial institution could be a securities brokerage company, a bank or credit union, a credit card company, or another type of financial institution. In this embodiment, the user software application 308 described herein may be an Internet browser application capable of facilitating communicating with the financial institution computer system to access information from pre-existing user accounts (e.g., obtain account balances to determine available funds), and provide payment instructions for making payments to vendors. In other embodiments, user software application 308 may include a different type of software application or package.

Software that at least facilitates receiving the request for information together with a format indication from software application 308 may reside on third party computer 306. Such software residing on third party computer 306 may at least partially respond to that request, or at least facilitate another computer system in responding to that request.

The user computer 302 includes a software application 308, data store 310, and data cache 312. The software application 308 includes a number of executable code portions and data files. These include code for creating and supporting a user interface 314 according to one embodiment of the present invention. In other embodiments, the software application 308 can also be implemented as part of a financial management software package. The software application 308 may be responsible for at least partially initiating the processes performed according to the methods of the present invention.

Any software portions described herein need not include discrete software modules. Any software configuration shown is meant only by way of example; other configurations are contemplated by and within the scope of various embodiments of the present invention.

The software application 308 may be provided to the user computer 302 on a computer readable media, such as a CD-ROM, DVD, diskette, or by electronic communication over the network 304 from one of the third party computers 306 or other distributors of software, for installation and execution thereon. Alternatively, the software application 308, data store 310, and data cache 312 can be hosted on a server computer, and accessed over the network 304 by the user, using for example a browser interface to the software application 308, where software application 308 is not a browser application itself.

The data store 310 may be a relational database or any other type of database that stores the data used by the software application 308. The data store 310 may be accessible by the software application 308 through the user interface 314. Some data from the data store 310 may be added to the data cache 312 upon initialization of the software application 308. The software application 308 and the data store 310 may be stored and operated on a single computer or on separate computer systems communicating with each other through a network 304.

The data cache 312 is a standard cache of small, fast memory holding recently accessed data. The data cache 312 may include, for example, one or more lists of elements according to one embodiment of the present invention.

One skilled in the art will recognize that the system architecture illustrated in FIG. 3 is merely exemplary, and that the invention may be practiced and implemented using many other architectures and environments.

FIG. 4 illustrates user interface 400 of an application generated using techniques of one embodiment of the present invention. User interface 400 is shown as it would be displayed within an Internet browser window. User interface 400 includes financial institution logo 402, balances section 404, account register section 406, and HTML component 408. HTML component 408 includes projected transactions section 410 and posted transactions section 412.

User interface 400 serves to display the appropriate information to user 102 (making reference to FIG. 1). User 102 takes actions (e.g., clicks on buttons or enters information in input fields) which are interpreted by user interface 400. Any number of interactions between user 102 and user interface 400 may occur before HTML component 408 is ultimately displayed. For example, in one embodiment user interface 400 may initially display other information and the user might click on a transactions button (not shown) which results in HTML component 408, including projected transactions 410 and posted transactions 412, being returned from web service 114 to workstation 104 (making reference to FIG. 1). User interfaces will vary, in accordance with various embodiments of the invention.

While to a user, HTML component 408 appears as any other portion of an HTML webpage, with no differentiation regarding the source of the various webpage sections, the HTML code for HTML component 408 was generated by web service 114 (referencing FIG. 1), and not by FI web server 108. In some embodiments, a passed HTML component may appear seamlessly as part of an HTML page, while in other embodiments a passed HTML component may be delineated as originating from a separate source. In some embodiments, such as the one illustrated in FIG. 4, the API that returned the HTML code for HTML component 408 can also switch into data mode to return applicable data in XML, such as would be needed if a user were to select buttons such as Match Transactions 414, Add Transaction 416, or Schedule Payments 418.

While the embodiment illustrated in connection with FIG. 4 deals with financial information, embodiments of the invention are by no means limited to such a context. Various embodiments of the invention may be used in many different contexts of user interaction with various forms of information, including, for example, the contexts of medical information, entertainment information, educational information, business information, information related to purchasing/selling goods/services, and communication information (e.g., messages, in various forms).

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may include a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks include storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method of configurably transmitting information, comprising:
receiving from a first server a request for the information together with a format indication;
transmitting by a second server, responsive to the format indication comprising a data indication, the information embedded in a data description markup language; and
transmitting by the second server, responsive to the format indication comprising a display indication, the information in a user interface component embedded in the data description markup language, the user interface component expressed in a display description markup language.

2. The method of claim 1, further comprising:
transmitting by the first server the information to a user.

3. The method of claim 1, wherein the format indication comprises a parameter passed in the request.

4. The method of claim 1, wherein the format indication may be set in a configuration operation.

5. The method of claim 1, wherein the request comprises a call to an application programming interface.

6. The method of claim 5, wherein the application programming interface comprises a web services application programming interface.

7. The method of claim 1, wherein the data description markup language comprises EXtensible Markup Language (XML).

8. The method of claim 1, wherein the data display markup language comprises Hyper Text Markup Language (HTML) or EXtensible HyperText Markup Language (XHTML).

9. A method of configurably requesting information, comprising:
transmitting by a first server a request for the information together with a format indication;
receiving from a second server, responsive to the transmitted format indication comprising a data indication, the information embedded in a data description markup language; and
receiving from the second server, responsive to the transmitted format indication comprising a display indication, the information in a user interface component embedded in the data description markup language, the user interface component ex-pressed in a data display markup language.

10. The method of claim 9, further comprising:
transmitting by the first server the information to a user.

11. The method of claim 9, wherein the format indication comprises a parameter passed in the request.

12. The method of claim 9, wherein the format indication may be set in a configuration operation.

13. A method of configurably transmitting information, comprising:
receiving from a first server a request for the information together with a data format indication and a display format indication, the data format indication associated with a first subset of the information and the display format indication associated with a second subset of the information;
transmitting by a second server, responsive to the data format indication, the first subset of the information embedded in a data description markup language; and
transmitting by the second server, responsive to the display format indication, the second subset of the information in a user interface component embedded in the data description markup language, the user interface component expressed in a display description markup language.

14. The method of claim 13, wherein the format indication comprises a parameter passed in the request.

15. The method of claim 13, wherein the format indication may be set in a configuration operation.

16. A method of configurably transmitting information, comprising:
receiving a call for the information together with a format indication; and
transmitting, by a web services application programming interface, the information in a markup language corresponding to the format indication.

17. A computer readable memory storing a computer program executable by one or more processors, the computer program for configurably transmitting information, comprising:
a computer-readable medium; and
computer program code, encoded in the medium, for:
receiving from a first server a request for the information together with a format indication,
transmitting by a second server, responsive to the format indication comprising a data indication, the information embedded in a data description markup language, and
transmitting by the second server, responsive to the format indication comprising a display indication, the information in a user interface component embedded in the data description markup language, the user interface component expressed in a display description markup language.

18. The computer program product of claim 17, wherein the format indication comprises a parameter passed in the request.

19. The computer program product of claim 17, wherein the format indication may be set in a configuration operation.

20. The computer program product of claim 17, wherein the request comprises a call to an application programming interface.

21. The computer program product of claim 20, wherein the application programming interface comprises a web services application programming interface.

22. The computer program product of claim 17, wherein the data description markup language comprises EXtensible Markup Language (XML).

23. The computer program product of claim 17, wherein the data display markup language comprises Hyper Text Markup Language (HTML) or EXtensible HyperText Markup Language (XHTML).

24. A computer readable memory storing a computer program executable by one or more processors, the computer program for configurably requesting information, comprising:
a computer-readable medium; and
computer program code, encoded in the medium, for:
transmitting by a first server a request for the information together with a format indication,
receiving from a second server, responsive to the transmitted format indication comprising a data indication, the information embedded in a data description markup language, and
receiving from the second server, responsive to the transmitted format indication comprising a display indication, the information in a user interface component embedded in the data description markup language, the user interface component ex-pressed in a data display markup language.

25. The computer program product of claim 24, wherein the format indication comprises a parameter passed in the request.

26. The computer program product of claim 24, wherein the format indication may be set in a configuration operation.
